(19) United States
(12) Patent Application Publication
(10) Pub. No.: US 2010/0176267 A1
(43) Pub. Date: Jul. 15, 2010

(54) STAND SET

(75) Inventor: Jie-Jin Chen, GuangDong Province (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: UNITED CHINESE PLASTICS PRODUCTS COMPANY LIMITED, Kowloon (HK)

(21) Appl. No.: 12/354,761

(22) Filed: Jan. 15, 2009

(51) Int. Cl. F16M 11/04

(52) U.S. Cl. 248/523

(57) ABSTRACT

A stand set includes a first component with a tube-shaped element and two first legs, a second component with a ring-shaped element and two second legs, and a third component with two clamping parts and two openings. The tube-shaped element has two locating ears, each provided with a through hole. An object can be inserted into the tube-shaped element for being supported and the first legs are connected to the tube-shaped element. The ring-shaped element and the tube-shaped element telescope with each other, wherein the first legs are engaged in two notches of the ring-shaped element. The second legs connect the ring-shaped element, each provided with a protrusion being inserted into the corresponding through hole. When detaching the second component from the first component, the third component can be assembled with the second component by inserting the protrusions into the openings and clamping the second legs through the clamping parts.

### BACKGROUND OF THE INVENTION

1. Field of the Invention

The present invention generally relates to a stand set, and more particularly, to the stand set in favor of being assembled and stored.

2. Description of Related Art

People usually decorate their houses by a Christmas tree at Christmas. For supporting and fixing the Christmas tree, a tree stand having sufficient structural strength is required to support and fix the Christmas tree reliably. Therefore, conventional tree stands are always fabricated in heavy and large. After the Christmas, the tree stand needs to be stored. However, the heavy weight or the large dimension is unfavorable for disassembly and occupies large space in storage.

A collapsible tree stand for supporting a Christmas tree is proposed in U.S. Pat. No. 5,290,004. However, even though a pair of legs can be collapsed, the tree stand of U.S. Pat. No. 5,290,004 is formed as a whole, which is still unfavorable for moving or storage. Furthermore, the legs of the tree stand of U.S. Pat. No. 5,290,004 are located and fixed in a same level. The tree stand may slant or topple when the legs are disposed on an uneven floor.

### SUMMARY OF THE INVENTION

Accordingly, the present invention is directed to a stand set, which is favorable for being assembled and stored, and provides stable support.

As embodied and broadly described herein, the present invention provides a stand set for standing an object. The stand set comprises a first component, a second component and a third component. The first component includes a tube-shaped element having a first end, a second end, a first exterior surface locating between the first end and the second end, and two locating ears oppositely disposed on the first exterior surface. Each locating ear has a through hole, and the object is inserted into the tube-shaped element from the first end. The first component further includes two first legs oppositely disposed on the first exterior surface of the tube-shaped element, wherein each first leg extends along a direction departing from the tube-shaped element. The second component can be assembled with the first component. The second component includes a ring-shaped element having a second exterior surface, at least one first fixing hole, and two opposite notch, wherein the ring-shaped element is disposed around the second end of the tube-shaped element and the two first legs are respectively engaged in the two notches. The second component also includes two second legs oppositely disposed on the second exterior surface, wherein each second leg extends along a direction departing from the ring-shaped element and has a protrusion, and the two protrusions of the two second legs are respectively inserted into the through holes of the two locating ears. The second component further includes at least one first fastener for penetrating the at least one first fixing hole and lean against the tube-shaped element. The third component has two openings and two clamping parts. When the second component is detached from the first component, the third component can be assembled with the second component by inserting the two protrusions into the two openings and clamping the two second legs through the two clamping parts.

According to an embodiment of the present invention, the stand set further comprises at least one second fastener penetrating at least one second fixing hole on the tube-shaped element to lean against the object.

According to an embodiment of the present invention, the two locating ears are adjacent to the first end

According to an embodiment of the present invention, an extending direction of the two through holes is substantially parallel to an extending direction of the tube-shaped element.

According to an embodiment of the present invention, an extending direction of the two protrusions is substantially parallel to an extending direction of the tube-shaped element.

According to an embodiment of the present invention, a diameter of each through hole is greater or substantially equal to a diameter of each protrusion.

According to an embodiment of the present invention, a width of each notch is greater or substantially equal to a width of each first leg.

According to an embodiment of the present invention, each first leg comprises: a first lower bar connected to a first portion of the tube-shaped element adjacent to the second end, wherein an extending direction of first lower bar is substantially perpendicular to an extending direction of the tube-shaped element; a first upper bar connected between a second portion of the tube-shaped element adjacent to the first end and a first free end of the first lower bar; and a first connecting bar connected between the first lower bar and the first upper bar.

According to an embodiment of the present invention, the first upper bar and the first lower bar forms a curved structure at their joint location.

According to an embodiment of the present invention, each second leg comprises: a second lower bar connected to the ring-shaped element, wherein an extending direction of the second lower bar is substantially perpendicular to an extending direction of the tube-shaped element; a supporting bar connected to a joint locating of the second lower bar and the ring-shaped element, wherein an extending direction of the supporting bar is substantially parallel to the extending direction of the tube-shaped element; a second upper bar connected a second free end of the second lower bar and a third free end of the supporting bar, wherein the supporting bar has a protrusion extending from the third free end; and a second connecting bar connecting between the second lower bar and the second upper bar.

According to an embodiment of the present invention, the second upper bar and the second lower bar forms a curved structure at their joint location.

In sum, the first component and the second component of the stand set of the present invention can be assembled together or detached apart in a simple and rapid manner. Moving or storage can be easily performed when detaching the first component and the second component. The third component is used for enhancing the structural strength of the second component when the second component is detached from the first component so as to protect the second component in storage.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a stand set according to an embodiment of the present invention.

FIG. 2 shows the first component of FIG. 1.

FIG. 3 shows the second component of FIG. 1.

FIG. 4 is a side view showing the second component and the third component being assembled together.

FIG. 5 is a perspective view of the third component.

FIG. 6 is a top view of the first component of FIG. 1.

FIG. 7 is a top view of the second component of FIG. 1.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

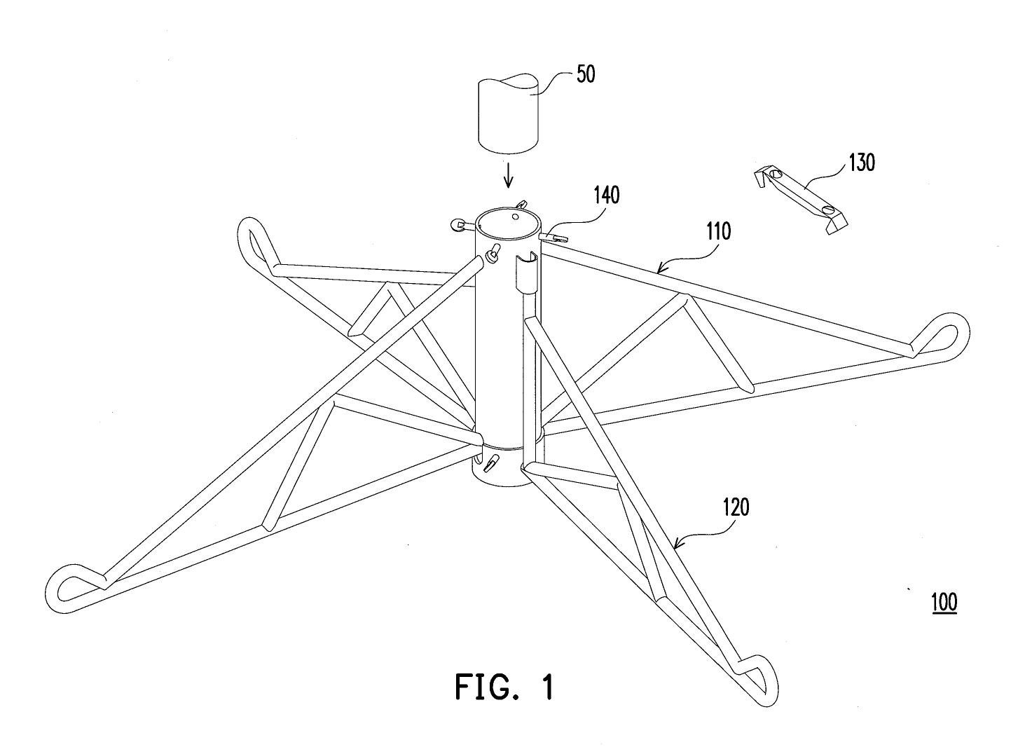

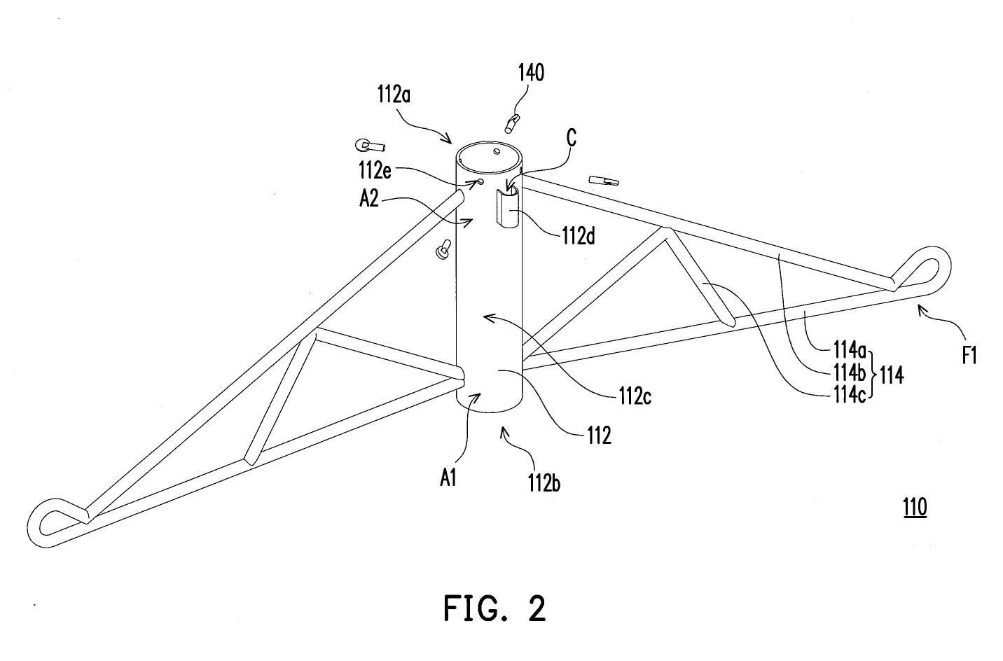

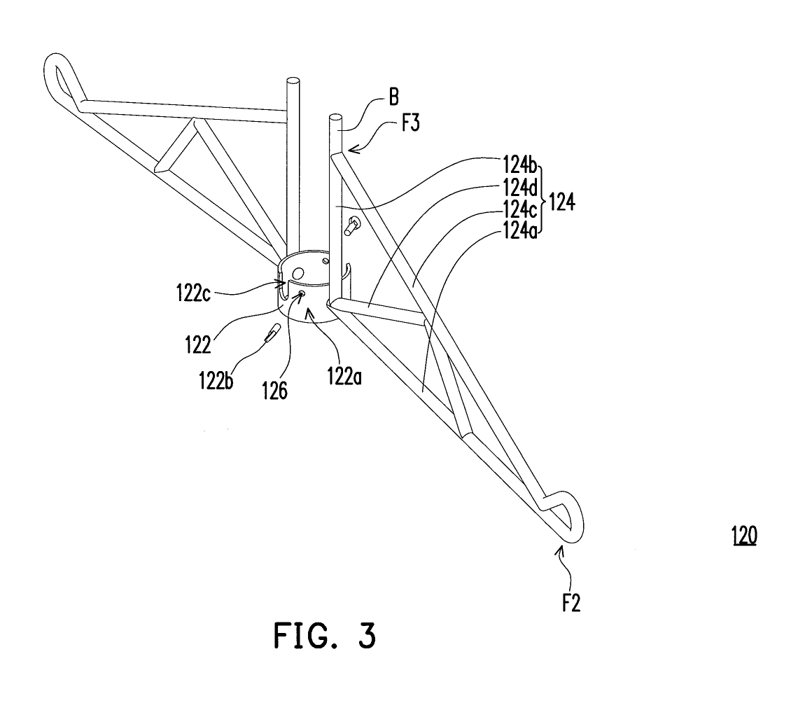

FIG. 1 is a perspective view of a stand set according to an embodiment of the present invention. FIG. 2 shows the first component of FIG. 1. FIG. 3 shows the second component of FIG. 1. Referring to FIGS. 1-3, the stand set 100 of this embodiment, for supporting an object 50 such as a Christmas tree or an artificial tree, includes a first component 110, a second component 120 and a third component 130.

The first component 110 includes a tube-shaped element 112 and two first legs. 114. The tube-shaped element 112 has a first end 112a, a second end 112b, a first exterior surface 112c located between the first end 112a and the second end 112b, and two opposite locating ears 112d disposed on the first exterior surface 112c. Each locating ear 112d has a through hole C, and the object 50 is inserted into the tube-shaped element 112 from the first end 112a. The two first legs 114 are disposed oppositely and connected to the first exterior surface 112c of the tube-shaped element 112. Each first leg 114 extends along a direction departing from the tube-shaped element 112.

The second component 120 is coupled with the first component 110. The second component 120 includes a ring-shaped element 122, two second legs 124 and at least one first fastener 122b. The ring-shaped element 122 has a second exterior surface 122a, at least one first fixing hole 126 and two opposite notches 122c. The ring-shaped element 122 is disposed around the second end 112b of the tube-shaped element 112 and the two first legs 114 are respectively engaged in the two notches 122c. The two second legs 124 are oppositely connected to the second exterior surface 122a, wherein each second leg 124 extends along a direction departing from the ring-shaped element 122 and forms a protrusion B. The protrusions B of the two second legs 124 are respectively inserted into the through holes C of the two locating ears 112d. The first fastener 122b passes through the first fixing hole 126 and leans against the tube-shaped element 112.

It is noted that when assembling the first component 110 and the second component 120 together, the ring-shaped element 122 is telescoped with the second end 112b of the tube-shaped element 112 while the protrusions B are respectively inserted into the through holes C and the first legs 114 are respectively engaged in the notches 122c. Then, the first fastener 122b is used in penetrating the first fixing hole 126 to lean against the tube-shaped element 112, and therefore accomplish the assembly of the first component 110 and the second component 120. When detaching the first component 110 and the second component 120 from each other, the tube-shaped element 112 can be taken from the ring-shaped element 122 by only loosing the first fastener 122b.

In this embodiment, the notches 122c have at least two functions. First, the relative position of the first component 110 and the second component 120 can be effectively fixed by the notches 122c so as to prevent the first component 110 and second component 120 collapse together due to an unexpected external force. In addition, in some circumstances, the floor where the stand set 100 is disposed may not be an even floor, that is, the floor may have a drop in height. In this embodiment, the notches 112c provided with an appropriate dimension can provide a tolerance of assembly between the first component 110 and the second component 120, so as to ensure that all of the first legs 114 and the second legs 124 can be exactly in contact with the floor when the first component 110 and the second component 120 are assembled and disposed on an uneven floor. The stand set 100 can be disposed on the floor stably.

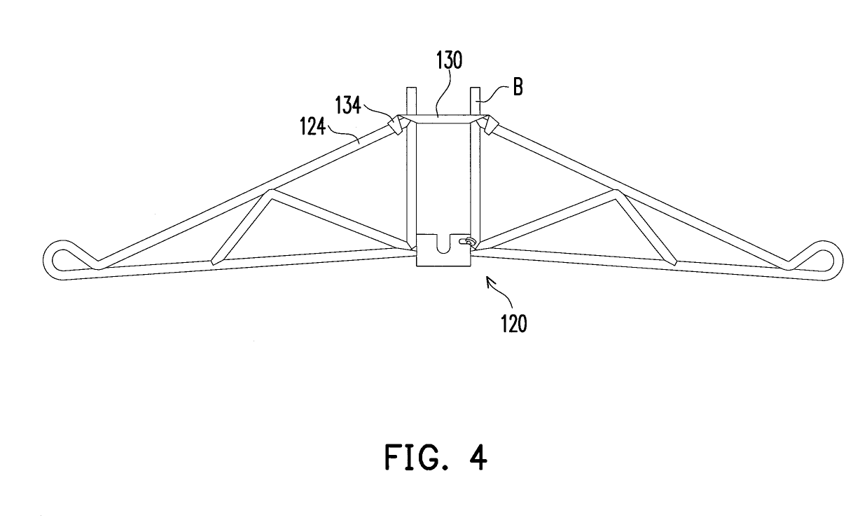

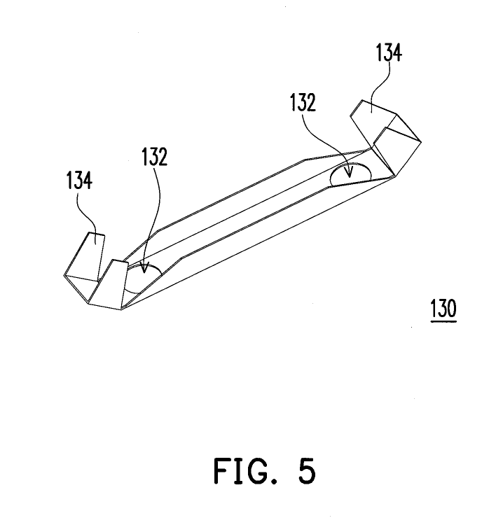

FIG. 4 is a side view showing the second component and the third component being assembled together. FIG. 5 is a perspective view of the third component. Referring to FIGS. 4 and 5, the third component 130 has two openings 132 and two clamping parts 134. When the second components 120 is detached from the first component 110 and is to be stored, the third component 130 can be used to assembled with the second component 120 by respectively inserting the two protrusions B into the two openings 132, and the two clamping parts 134 respectively clamp the two second legs 124, so as to improve the structural strength and prevent damage in moving or storage.

Referring to FIGS. 1, 2 and 3, in this embodiment, the aforementioned stand set 100 further includes at least one second fastener 140, which passes through a second fixing hole 112e of the tube-shaped element 112 to lean against the object 50. The two first legs 114 are perpendicular to the two second legs 124. The stand set 100 and the object 50 can stand stably on the floor by the two first legs 114 and the two second legs 124 in contact with the floor. The object 50 of this embodiment can be a Christmas tree or other applicable objects in demand of being fixed and supported.

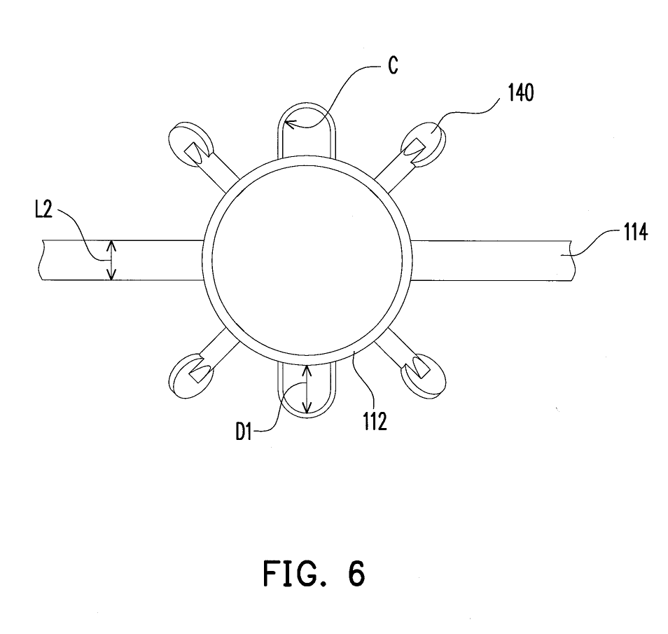

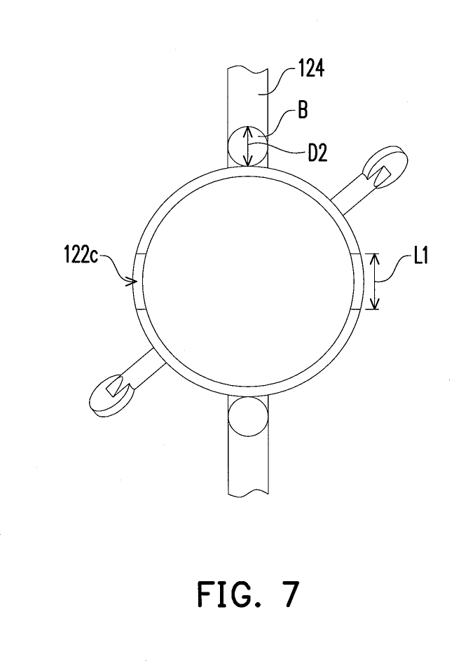

FIG. 6 is a top view of the first component of FIG. 1. FIG. 7 is a top view of the second component of FIG. 1. Referring to FIGS. 6 and 7, the two locating ears 112d are adjacent to the first end 112a. The two through holes C and the two protrusions B extend along a direction substantially in parallel to the extending direction of the tube-shaped element 112. Each through hole C has a diameter D1 greater or substantially equal to a diameter D2 of each protrusion B, such that the two protrusions B can be inserted into the two through holes C. In addition, each notch 122c has a width L1 greater or substantially equal to a width L2 of each first leg 114, such that the two first legs 114 can be engaged in the two notches 122c.

The detailed structures of the first legs 114 and the second legs 124 are illustrated in the following. Referring to FIGS. 1 and 2, in this embodiment, each first leg 114 includes a first lower bar 114a, a first upper bar 114b and first connecting bars 114b. The first lower bar 114a is connected to a first portion A1 of the tube-shaped element 112 adjacent to the second end 112b, wherein the first lower bar 114a extends along a direction substantially perpendicular to the extending direction of the tube-shaped element 112.

The first upper bar 114b is connected between a second portion A2 of the tube-shaped element 112 adjacent to the first end 112a and a first free end F1 of the first lower bar 114a. The first connecting bars 114b are connected between the first lower bars 114a and the first upper bar 114b so as to enhance the structural strength of the first leg 114. In addition, the first upper bar 114b and the first lower bar 114a forms a curved structure at their joint location, which can prevent users from being hurt by a sharp edge at the joint location between the first upper bar 114b and the first lower bar 114a in using or assembling.

Referring to FIGS. 1 and 3, in this embodiment, each second leg 124 includes a second lower bar 124a, a supporting bar 124b, a second upper bar 124b and second connecting bars 124d. The second lower bar 124a is connected to the ring-shaped element 122, wherein the second lower bar 124a extends along a direction perpendicularly to the extending direction of the tube-shaped element 112. The supporting bar 124b is connected to the joint location of the second lower bar 124a and the ring-shaped element 122, wherein the supporting bar 124b extends along a direction in parallel with the extending direction of the tube-shaped element 112.

The second upper bar 124b is connected between a second free end F2 of the second lower bar 124a and a third free end F3 of the supporting bar 124b. The supporting bar 124b extends a protrusion B from the third free end F3. The second connecting bars 124d are connected between the second lower bar 124a and the second upper bar 124b. Furthermore, the second upper bar 124b and the second lower bar 124a forms a curved structure at their joint location, which can prevent users from being hurt by a sharp edge at the joint location between the first upper bar 114b and the first lower bar 114a in using or assembling.

To sum up, the first component and the second component of the stand set of the present invention can be assembled together or detached apart in a simple and rapid manner. Moving or storage can be easily performed when detaching the first component and the second component. The third component is used for enhancing the structural strength of the second component when the second component is detached from the first component so as to protect the second component in storage. In addition, the relative position of the first component and the second component can be limited by the notches so as to ensure the assembly between the first component and the second component. Furthermore, the notches provide a tolerance of assembly between the first component and the second component, so as to overcome the topographic variation of the floor, and thus the stand set can be disposed on the floor stably.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A stand set for standing an object, the stand set comprising:
a first component, comprising:
a tube-shaped element having a first end, a second end, a first exterior surface locating between the first end and the second end, and two locating ears oppositely disposed on the first exterior surface, wherein each locating ear has a through hole, and the object is inserted into the tube-shaped element from the first end;
two first legs oppositely disposed on the first exterior surface of the tube-shaped element, wherein each first leg extends along a direction departing from the tube-shaped element;
a second component for being assembled with the first component, the second component comprising:
a ring-shaped element having a second exterior surface, at least one first fixing hole, and two opposite notch, wherein the ring-shaped element is disposed around the second end of the tube-shaped element and the two first legs are respectively engaged in the two notches;
two second legs oppositely disposed on the second exterior surface, wherein each second leg extends along a direction departing from the ring-shaped element and has a protrusion, and the two protrusions of the two second legs are respectively inserted into the through holes of the two locating ears;
at least one first fastener for penetrating the at least one first fixing hole and lean against the tube-shaped element; and
a third component having two openings and two clamping parts, wherein when the second component is disassembled from the first component, the third component is used for being assembled with the second component by inserting the two protrusions into the two openings and clamping the two second legs through the two clamping parts.

2. The stand set according to claim 1, further comprising at least one second fastener penetrating at least one second fixing hole on the tube-shaped element to lean against the object.

3. The stand set according to claim 1, wherein the two locating ears are adjacent to the first end

4. The stand set according to claim 1, wherein an extending direction of the two through holes is substantially parallel to an extending direction of the tube-shaped element.

5. The stand set according to claim 1, wherein an extending direction of the two protrusions is substantially parallel to an extending direction of the tube-shaped element.

6. The stand set according to claim 1, wherein a diameter of each through hole is greater or substantially equal to a diameter of each protrusion.

7. The stand set according to claim 1, wherein a width of each notch is greater or substantially equal to a width of each first leg.

8. The stand set according to claim 1, wherein each first leg comprises:
a first lower bar connected to a first portion of the tube-shaped element adjacent to the second end, wherein an extending direction of first lower bar is substantially perpendicular to an extending direction of the tube-shaped element;
a first upper bar connected between a second portion of the tube-shaped element adjacent to the first end and a first free end of the first lower bar; and
a first connecting bar connected between the first lower bar and the first upper bar.

9. The stand set according to claim 8, wherein the first upper bar and the first lower bar forms a curved structure at their joint location.

10. The stand set according to claim 1, wherein each second leg comprises:
a second lower bar connected to the ring-shaped element, wherein an extending direction of the second lower bar is substantially perpendicular to an extending direction of the tube-shaped element;
a supporting bar connected to a joint locating of the second lower bar and the ring-shaped element, wherein an extending direction of the supporting bar is substantially parallel to the extending direction of the tube-shaped element;
a second upper bar connected a second free end of the second lower bar and a third free end of the supporting bar, wherein the supporting bar has a protrusion extending from the third free end; and
a second connecting bar connecting between the second lower bar and the second upper bar.

11. The stand set according to claim 10, wherein the second upper bar and the second lower bar forms a curved structure at their joint location.
